(19) United States
(12) Patent Application Publication
(10) Pub. No.: US 2024/0031545 A1
(43) Pub. Date: Jan. 25, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SAEKO OISHI, Kanagawa (JP)

(21) Appl. No.: 18/353,191

(22) Filed: Jul. 17, 2023

(30) Foreign Application Priority Data
Jul. 21, 2022 (JP) 2022-116302

(51) Int. Cl. H04N 13/133; H04N 23/73; H04N 13/344

(52) U.S. Cl. CPC H04N 13/133; H04N 23/73; H04N 13/344

(57) ABSTRACT

A captured image obtaining unit obtains a captured image of a background camera. A luminance information deriving unit transforms a color image of the obtained captured image to a luminance image, and calculates maximum luminance values in a capture angle-of-view region and a display angle-of-view region, based on the obtained luminance image. A control parameter setting unit determines whether an absolute difference between the obtained maximum luminance values is equal to or larger than a predetermined threshold, and determines exposure of the background camera based on the luminance information of the captured angle-of-view region or the display angle-of-view region, based on the determination result. An image processing unit generates a displayed image by cutting out the display angle-of-view region from the captured image of the background camera for which an imaging parameter is set based on the determined exposure.

### CROSS REFERENCE TO PRIORITY APPLICATION

This application claims the benefit of Japanese Patent Application No. 2022-116302 filed Jul. 21, 2022, which is hereby incorporated by reference herein in its entirety.

### FIELD OF THE INVENTION

The present disclosure relates to an image processing technique in the case where part of a captured image is used as a displayed image.

### BACKGROUND OF THE INVENTION

In recent years, services assuming use of a video see-through head mounted display (HMD) that is an HMD equipped with an imaging apparatus are increasing. The video see-through HMD can capture an image of an environment in front of the eyes of a user by using a background camera that is the imaging apparatus attached to the HMD, and display an image generated by superimposing a CG or the like on the captured image, on the HMD.

The video see-through HMD as described above is generally set such that the captured image obtained by being captured with the background camera is an image with a wider angle of view than the displayed image displayed on a display included in the HMD to facilitate alignment of the captured image and the displayed image.

Moreover, in the HMD, exposure of the background camera is adjusted to appropriately set brightness of the image to be displayed on the display. Since frequent changes in the exposure of the background camera with movement of the head of the user cause visually induced motion sickness and a decrease in realistic sensation, the exposure of the background camera is determined based on the captured image with a wider angle of view than the displayed image in many cases. Japanese Patent Laid-Open No. 2021-019314 discloses a technique in which exposure of an imaging apparatus is adjusted depending on a luminance characteristic of a display apparatus to appropriately set brightness of an image to be displayed on a display apparatus.

### SUMMARY OF THE INVENTION

The present disclosure is an information processing apparatus comprising: an image obtaining unit that obtains a captured image obtained by being captured with an imaging apparatus; an image processing unit that generates a displayed image with a smaller angle of view than the captured image by cutting out part of the captured image; a deriving unit that derives a luminance image based on the captured image; and a setting unit that sets a control parameter for adjusting brightness of the displayed image based on a region corresponding to the displayed image and a region corresponding to a light source in the luminance image.

Further features of the present invention will become apparent from the following description of exemplary embodiments with reference to the attached drawings.

### BRIEF DESCRIPTION OF THE DRAWINGS

FIG. 1 is a schematic diagram illustrating a system configuration of an HMD;

FIG. 2 is a schematic diagram illustrating a system configuration of an information processing apparatus;

FIG. 3A is a block diagram illustrating a functional configuration of the information processing apparatus in Embodiment 1;

FIG. 3B is a block diagram illustrating a functional configuration of the information processing apparatus in Embodiment 1;

FIG. 4 is an explanatory diagram of a capture angle-of-view region and a display angle-of-view region in a captured image;

FIG. 5A is an explanatory diagram of processing of a control parameter setting unit in Embodiment 1;

FIG. 5B is an explanatory diagram of the processing of the control parameter setting unit in Embodiment 1;

FIG. 5C is an explanatory diagram of the processing of the control parameter setting unit in Embodiment 1;

FIG. 6 is an explanatory diagram of effects of the control parameter setting unit in Embodiment 1;

FIG. 7 is a flowchart illustrating a flow of processing in Embodiment 1;

FIG. 8A is a block diagram illustrating a functional configuration of an information processing apparatus in Embodiment 2;

FIG. 8B is a block diagram illustrating a functional configuration of the information processing apparatus in Embodiment 2;

FIG. 9 is an explanatory diagram of processing of a control parameter setting unit in Embodiment 2;

FIG. 10 is a flowchart illustrating a flow of processing in Embodiment 2;

FIG. 11A is a block diagram illustrating a functional configuration of an information processing apparatus in Embodiment 3;

FIG. 11B is a block diagram illustrating a functional configuration of the information processing apparatus in Embodiment 3; and

FIG. 12 is a flowchart illustrating a flow of processing in Embodiment 3.

### DESCRIPTION OF THE EMBODIMENTS

Embodiments of the present disclosure are described below with reference to the drawings. Note that the following embodiments do not limit the present disclosure, and not all of combinations of the features described in the present embodiments are necessarily essential for the solving means of the present disclosure. Note that the identical configurations are described while being denoted with the same reference numerals.

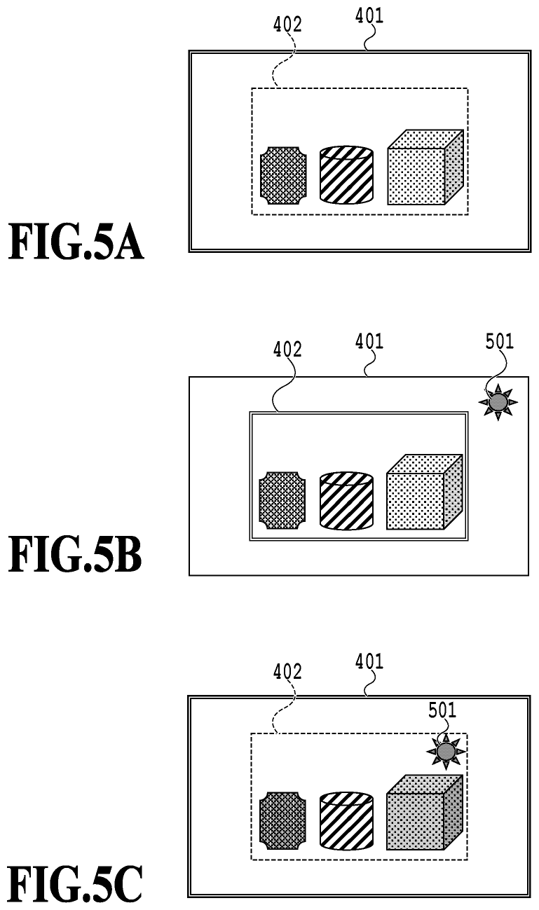

In the technique of Japanese Patent Laid-Open No. 2021-019314, appropriate exposure can be set in the case where an angle of view of a captured image matches an angle of view of a displayed image. However, in the case where part of the captured image is set as the displayed image as in a video see-through HMD, the exposure sometimes cannot be appropriately set. For example, in the video see-through HMD, in the case where a high-luminance light source is present in a region of the captured image that is outside the displayed image as illustrated in FIG. 5B, exposure of a background camera is influenced by the light source, and is set to a low level. Accordingly, there are cases where brightness of a subject is low even though the light source is not captured in the displayed image, or cases where shadow-detail loss or the like occurs in the subject depending on the intensity of the luminance of the light source. Since a decrease in the brightness of the subject, the shadow-detail loss, and the like are caused by the light source that is not present in the field of view of a user, a decrease in visibility that is unnatural to the user occurs.

### Embodiment 1

In Embodiment 1, description is given of processing in which, in the case where an HMD is determined to be in a scene in which a visibility decrease occurs, exposure of a background camera at which the visibility decrease of the HMD is suppressed is determined. In the present embodiment, the exposure of the background camera is determined based on luminance information of a captured image and luminance information of a displayed image that is generated based on the captured image and that has a smaller angle of view than the captured image. To be more specific, the exposure is determined based on the luminance information of the displayed image in the case where a difference between a luminance value of the captured image and a luminance value of the displayed image is equal to or larger than a threshold, and is determined from the luminance information of the captured image in the case where the difference between the luminance values is smaller than the threshold.

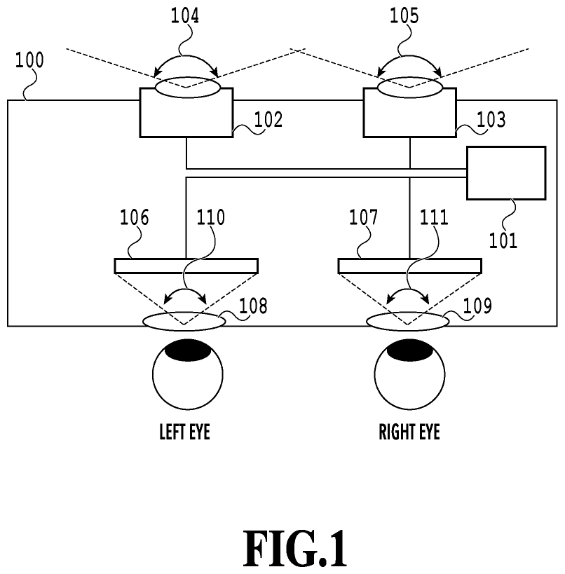

FIG. 1 is a schematic diagram illustrating a system configuration of an HMD 100. The HMD 100 is a video see-through HMD, and is an apparatus that is worn on the head of a not-illustrated user and that presents a left-eye displayed image and a right-eye displayed image to the left eye and the right eye of the user. The HMD 100 includes inside an information processing apparatus 101, and the information processing apparatus 101 performs communication of image data, control signals, and the like with the HMD 100. Details of the information processing apparatus 101 are described later. In the present embodiment, description is given of a system configuration in which the information processing apparatus 101 included inside the HMD 100 executes various types of processing, and the HMD 100 operates alone. However, there may be employed a system configuration in which the information processing apparatus 101 is an external apparatus independent from the HMD 100, and is connected to the HMD 100 as a not-illustrated information processing apparatus.

The HMD 100 includes a left-eye background camera 102 and a right-eye background camera 103 used to obtain an environment in front of the eyes of the user as captured images. Capture angles of view of these background cameras are a left-eye capture angle of view 104 and a right-eye capture angle of view 105, respectively. Note that, in the present embodiment, the left and right capture angles of view are assumed to be equal to simplify explanation, and are also simply referred to by using an expression of capture angle of view. Moreover, the HMD 100 includes a left-eye display 106 and a right-eye display 107 formed of display panels such as liquid crystal panels or organic EL panels to present images to the user. Furthermore, a left-eye eyepiece lens 108 and a right-eye eyepiece lens 109 are arranged in front of these displays, and the user views enlarged virtual images of the displayed images displayed on the displays through these lenses. Display angles of view of display units formed of these displays and lenses are a left-eye display angle of view 110 and a right-eye display angle of view 111, respectively. Note that, in the present embodiment, the left and right display angles of view are assumed to be equal to simplify expression, and are also simply referred to by using an expression of display angle of view. It is assumed that the left-eye capture angle of view 104 and the right-eye capture angle of view 105 that are the capture angle of view of the background cameras are designed to be wider than the left-eye display angle of view 110 and the right-eye display angle of view 111 that are the display angle of view of the display units, respectively.

The HMD 100 also includes not-illustrated various sensors used to obtain the position and orientation of the user.

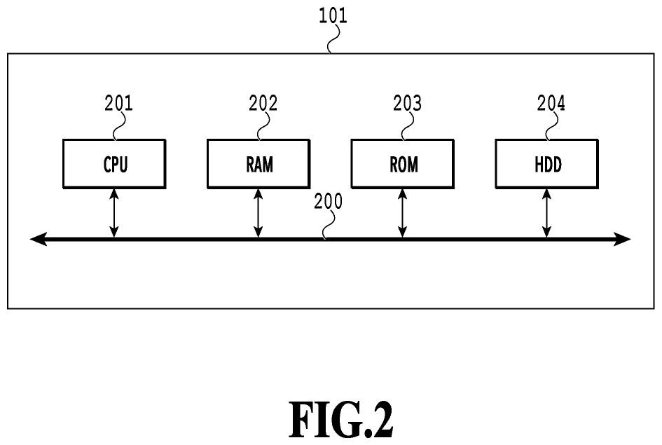

FIG. 2 is a schematic diagram illustrating a hardware configuration of the information processing apparatus 101 in the present disclosure. The information processing apparatus 101 includes a CPU 201, a RAM 202, a ROM 203, and an HDD 204, and these units are connected to one another via a main bus 200. The CPU 201 is a processor that integrally controls the units in the information processing apparatus 101. The RAM 202 functions as a main memory, a work area, and the like of the CPU 201. The ROM 203 stores a program group to be executed by the CPU 201. The HDD 204 stores an application to be executed by the CPU 201, data used in image processing, and the like.

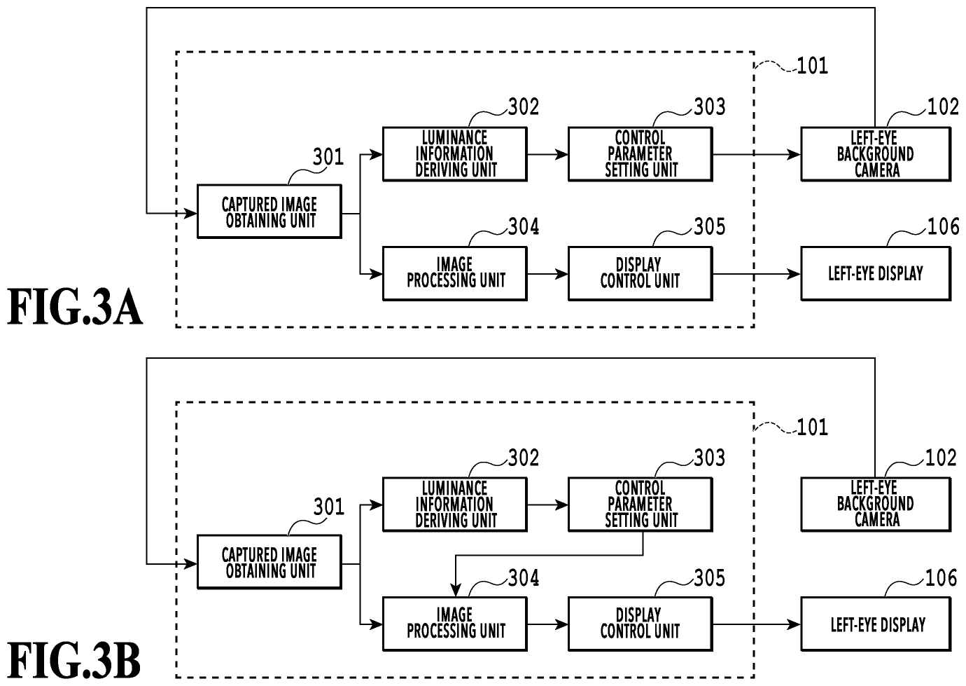

FIGS. 3A and 3B are block diagrams illustrating software configurations implemented by the CPU 201 of the information processing apparatus 101 in the present embodiment executing a program. Functions of each unit are described below by using FIGS. 3A and 3B. As illustrated in FIGS. 3A and 3B, two configurations varying in a method of feedback control can be adopted as the configuration of the information processing apparatus 101 in the present embodiment. In the configuration illustrated in FIG. 3A, exposure settings of the background cameras 102 and 103 are adjusted based on control parameters set by a control parameter setting unit 303. Meanwhile, in the configuration illustrated in FIG. 3B, there is performed image processing in which an image processing unit 304 adjusts the brightness of the displayed images based on the control parameters set by the control parameter setting unit 303. Although the processing is performed on both of the left-eye image and the right-eye image in the block of each unit, since the contents of the processing are identical, description is given only of the processing performed on the left-eye image in the following explanation, and description of the processing performed on the right-eye image is omitted. Moreover, the right-eye background camera 103, the right-eye display 107, the right-eye eyepiece lens 109, the right-eye capture angle of view 105, and the right-eye display angle of view 111 are assumed to be used in the processing performed on the right-eye image.

A captured image obtaining unit 301 obtains the captured image captured by the left-eye background camera 102. The captured image is, for example, a color image that stores an 8-bit color signal value of each of RGB for each pixel.

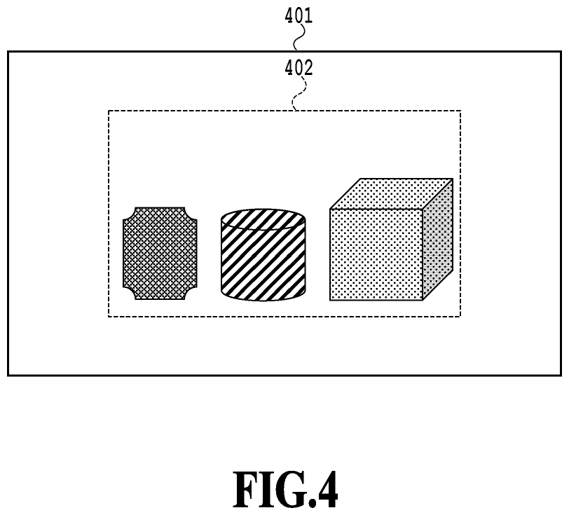

A luminance information deriving unit 302 calculates the maximum luminance value in the left-eye captured image obtained by the captured image obtaining unit 301 and the maximum luminance value in an image region of the left-eye captured image corresponding to the left-eye display angle of view 110. First, the luminance information deriving unit 302 transforms the RGB color image of the captured image to an image (hereinafter referred to as luminance image) formed of luminance signal values Y. Various methods of transforming the RGB values to the luminance signal values Y are known, and any of these methods may be used. For example, it is possible to use a method in which the RGB color signals values are transformed to R′G′B′ signal values that are linear to luminance by gamma transformation, and then a publicly-known matrix operation using a transformation matrix for transformation from the R′G′B′ signal values to XYZ signal values is performed to obtain the luminance signal values Y. Alternatively, a linear formula that transforms the RGB signal values to the luminance signal values Y may be used for each of the pixels in the RGB color image. Then, the luminance information deriving unit 302 calculates the maximum luminance value in the calculated luminance image and the maximum luminance value in the display angle of view. FIG. 4 illustrates an example of the luminance image. A capture angle-of-view region 401 (solid line region in FIG. 4) is an image region corresponding to the capture angle of view, and is equal to an entire region of the captured image obtained by the left-eye background camera 102. A display angle-of-view region 402 (broken line region in FIG. 4) is an image region displayed on the left-eye display 106, and is a region included in the capture angle-of-view region 401. Specifically, the capture angle of view is assumed to be wider than the display angle of view.

The control parameter setting unit 303 compares the maximum luminance value of the capture angle-of-view region 401 and the maximum luminance value of the display angle-of-view region 402 calculated in the luminance information deriving unit 302, and determines the exposure of the left-eye background camera 102. In the present embodiment, the exposure of the left-eye background camera 102 is determined from the display angle-of-view region 402 in the case where an absolute value of a difference (absolute difference) between the maximum luminance value of the capture angle-of-view region 401 and the maximum luminance value of the display angle-of-view region 402 is equal to or larger than a threshold, and is determined from the capture angle-of-view region 401 in the case where the absolute value is smaller than the threshold. The threshold described herein is a threshold that can be used to distinguish a scene in which a difference between the luminance in the capture angle-of-view region and the luminance in the display angle-of-view region is large due to presence of a light source in the captured image.

FIGS. 5A to 5C are schematic diagrams of the luminance images calculated in the luminance information deriving unit 302, and processing in the control parameter setting unit 303 is described by using FIGS. 5A to 5C. Each of the luminance images illustrated in FIGS. 5A to 5C includes the capture angle-of-view region 401 and the display angle-of-view region 402, and a light source 501 is captured in each of the luminance images of FIGS. 5B and 5C. In FIG. 5A, no light source is present in the capture angle-of-view region 401 or the display angle-of-view region 402. In FIG. 5B, the light source 501 is present in the capture angle-of-view region 401, but is absent in the display angle-of-view region 402. In FIG. 5C, the light source 501 is present in both of the capture angle-of-view region 401 and the display angle-of-view region 402. Moreover, the light source 501 is assumed to be an object with higher luminance than luminance of a subject, and to be an object with such a luminance value that the presence of the light source 501 in the captured image greatly increases the maximum luminance value.

Since no light source is present in the capture angle-of-view region 401 and the display angle-of-view region 402 in FIG. 5A, the maximum luminance value of the capture angle-of-view region 401 and the maximum luminance value of the display angle-of-view region 402 are both relatively small. As a result, the absolute difference between the maximum luminance value of the capture angle-of-view region 401 and the maximum luminance value of the display angle-of-view region 402 is smaller than the threshold set in advance. Accordingly, the exposure setting of the left-eye background camera 102 is to be obtained based on the left-eye capture angle-of-view region 401 (double line region in FIG. 5A). In FIG. 5B, since the light source 501 is present in the capture angle-of-view region 401 but is absent in the display angle-of-view region 402, the maximum luminance value of the capture angle-of-view region 401 is large but the maximum luminance value of the display angle-of-view region 402 remains small. As a result, the absolute difference between the maximum luminance value of the capture angle-of-view region 401 and the maximum luminance value of the display angle-of-view region 402 is larger than the threshold set in advance. Accordingly, the exposure setting of the left-eye background camera 102 is to be obtained based on the left-eye display angle-of-view region 402 (double line region in FIG. 5B). In FIG. 5C, since the light source 501 is captured in both of the capture angle-of-view region 401 and the display angle-of-view region 402, the maximum luminance value of the capture angle-of-view region 401 and the maximum luminance value of the display angle-of-view region 402 are both large. As a result, the absolute difference between the maximum luminance value of the capture angle-of-view region 401 and the maximum luminance value of the display angle-of-view region 402 is smaller than the threshold set in advance. Accordingly, the exposure setting of the left-eye background camera 102 is to be obtained based on the left-eye capture angle-of-view region 401 (double line region in FIG. 5C). Effects of this method of determining the exposure in the control parameter setting unit 303 are described later.

In the configuration illustrated in FIG. 3A, the control parameter setting unit 303 sets the left-eye background camera 102 such that the exposure is determined based on the angle-of-view region (left-eye capture angle-of-view region 401 or left-eye display angle-of-view region 402) to be used for the calculation of the exposure. For example, setting of a photometric range in a not-illustrated photometric sensor attached to the left-eye background camera 102 is set to correspond to the capture angle of view or the display angle of view matching the angle-of-view region to be used for the calculation of the exposure. Alternatively, an imaging parameter other than the photometric range in the case where the captured image is obtained in the left-eye background camera 102 may be adjusted based on the luminance of the angle-of-view region to be used for the calculation of the exposure. The imaging parameter adjusted in this case includes ISO sensitivity, shutter speed, an aperture value, and the like of the left-eye background camera 102.

Meanwhile, in a configuration illustrated in FIG. 3B, the control parameter setting unit 303 may adjust a luminance level of the displayed image in the image processing unit 304 to be described later, instead of adjusting the exposure setting of the background camera. In this case, the control parameter setting unit 303 adjusts an image processing parameter, for example, a gamma value of the image processing unit 304 to adjust the luminance level of the displayed image depending on the luminance information of the angle-of-view region to be used for the calculation of the exposure.

The image processing unit 304 generates the displayed image to be displayed on the left-eye display 106 by cutting out the display angle-of-view region from the left-eye captured image obtained in the captured image obtaining unit 301. Moreover, in the configuration in which the image processing unit 304 obtains the image processing parameter from the control parameter setting unit 303 as in FIG. 3B, the image processing unit 304 also performs the processing of adjusting the luminance level of the displayed image based on the obtained image processing parameter.

A display control unit 305 displays the displayed image generated in the image processing unit 304 based on the captured image of the left-eye background camera 102, on the left-eye display 106.

### Effects of Exposure Determination Method in Control Parameter Setting Unit 303

Effects of the exposure determination method in the control parameter setting unit 303 that are the features of the present embodiment are described.

In a scene in which no light source is present in the capture angle-of-view region 401 or the display angle-of-view region 402 as in FIG. 5A, the visibility decrease of the subject due to the light source does not occur, and the control parameter setting unit 303 thus determines the exposure based on the luminance information of the capture angle-of-view region 401. In this case, the exposure is determined based on the luminance information of the capture angle-of-view region 401 to prevent frequent exposure changes with movement of the head of the user and to inhibit visually induced motion sickness and a decrease in realistic sensation of the user.

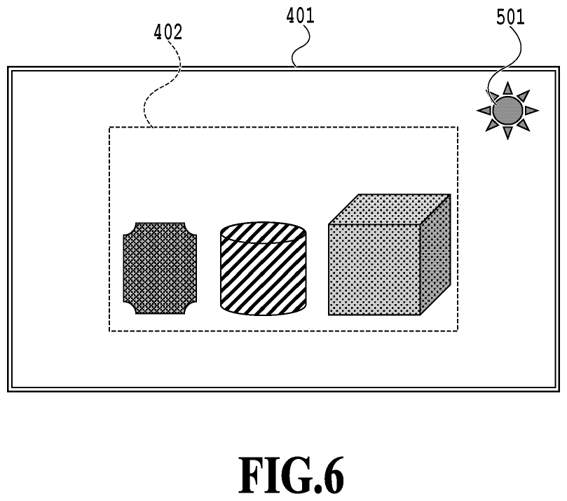

Meanwhile, in a scene in which the light source 501 is present in the capture angle-of-view region 401 but is absent in the display angle-of-view region 402 as in FIG. 5B, the control parameter setting unit 303 determines the exposure based on the luminance information of the display angle-of-view region 402. In this case, the exposure is determined based on the luminance information of the display angle-of-view region 402 because, if the exposure is determined based on the luminance information of the capture angle-of-view region 401, the luminance of the subject is insufficient and the visibility decreases. In the case where the exposure is determined by using the maximum luminance value of the capture angle-of-view region 401 as illustrated in FIG. 6, the exposure is set to a low level due to an influence of the light source 501, and there is a possibility that the brightness of the subject in the display angle-of-view region 402 decreases and the visibility decreases. Moreover, shadow-detail loss of the subject may sometimes occur depending on the intensity of the luminance of the light source 501. Furthermore, since a change in brightness due to the light source 501 that is in a region unviewable to the user is a change unnatural to the user, this change decreases the user experience. Accordingly, the exposure is determined based on the display angle-of-view region 402 not including the light source 501 unviewable to the user to inhibit the decrease in brightness and the decrease in visibility of the user such as the shadow-detail loss due to the light source 501 unviewable to the user.

In a scene in which the light source 501 is present in both of the capture angle-of-view region 401 and the display angle-of-view region 402 as in FIG. 5C, the control parameter setting unit 303 determines the exposure based on the luminance information of the capture angle-of-view region 401 as in the case of FIG. 5A. In this case, since the light source 501 is in a state visible also to the user and the subject appearing dark due to the light source 501 that is in sight of the user is a natural appearance, the exposure is determined based on the luminance information of the capture angle-of-view region 401 to prevent frequent exposure changes described above.

As described above, in the present embodiment, the control parameter setting unit 303 determines whether the light source 501 is located in the capture angle-of-view region 401 or the display angle-of-view region 402, depending on whether the difference between the maximum luminance value of the capture angle-of-view region 401 and the maximum luminance value of the display angle-of-view region 402 is equal to or larger than the threshold. Then, the control parameter setting unit 303 determines the exposure based on the luminance information of the display angle-of-view region 402 in the case where the difference between the maximum luminance value of the capture angle-of-view region 401 and the maximum luminance value of the display angle-of-view region 402 is equal to or larger than the threshold value, and determines the exposure based on the luminance information of the capture angle-of-view region 401 in the case where the difference is smaller than the threshold. This can inhibit the decrease in visibility while preventing the visually induced motion sickness and the decrease in realistic sensation of the user.

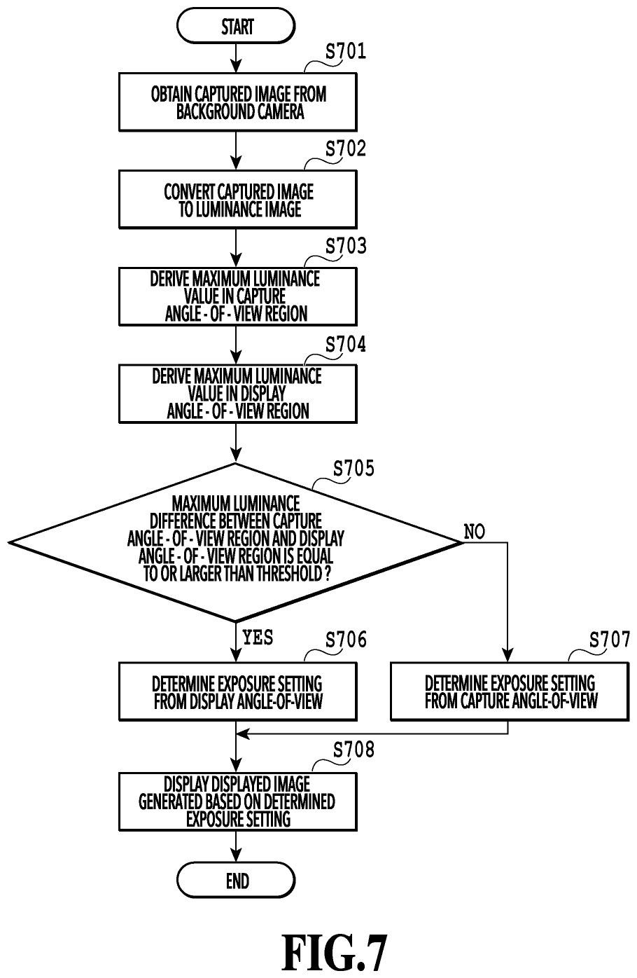

Next, description is given by using a flowchart of control parameter setting processing for the displayed image that is illustrated in FIG. 7 and that is performed in the configuration of FIG. 3A of the HMD 100 in the present embodiment. As described above, the processing for the left eye is described, and the description of the processing for the right eye is omitted.

In S701, the captured image obtaining unit 301 obtains the captured image of the left-eye background camera 102, and the processing proceeds to S702.

In S702, the luminance information deriving unit 302 transforms the color image of the captured image obtained in S701 to the luminance image, and the processing proceeds to S703.

In S703, the luminance information deriving unit 302 calculates the maximum luminance value in the capture angle-of-view region 401, based on the luminance image obtained in S702, and the processing proceeds to S704.

In S704, the luminance information deriving unit 302 calculates the maximum luminance value in the display angle-of-view region 402, based on the luminance image obtained in S702, and the processing proceeds to S705.

In S705, the control parameter setting unit 303 determines whether the absolute difference between the maximum luminance value of the capture angle-of-view region 401 obtained in S703 and the maximum luminance value of the display angle-of-view region 402 obtained in S704 is equal to or larger than the predetermined threshold. The processing proceeds to S706 in the case where the absolute difference is equal to or larger than the threshold in this determination, and proceeds to S707 in the case where the absolute difference is smaller than the threshold.

In S706, the control parameter setting unit 303 determines the exposure of the left-eye background camera 102 based on the luminance information of the display angle-of-view region 402, and the processing proceeds to S708.

In S707, the control parameter setting unit 303 determines the exposure of the left-eye background camera 102 based on the luminance information of the capture angle-of-view region 401, and the processing proceeds to S708.

In S708, the image processing unit 304 cuts out the display angle-of-view region from the captured image of the left-eye background camera 102 for which the imaging parameter is set based on the exposure determined in S706 or S707, and generates the displayed image. The display control unit 305 displays the generated displayed image on the left-eye display 106. In the case where the process of this step is completed, the series of processes in the present embodiment is terminated.

In the configuration of FIG. 3B, in each of S706 and S707, the control parameter setting unit 303 determines the image processing parameter used to adjust the brightness of the displayed image, based on the luminance information of a corresponding one of the angle-of-view regions. In S708, the image processing unit 304 cuts out the display angle-of-view region from the captured image of the left-eye background camera 102, and generates the displayed image. Then, the display control unit 305 adjusts the brightness by using the determined image processing parameter, and displays the image on the left-eye display 106.

As described above, the angle of view to be used for the calculation of the exposure of each of the background cameras 102 and 103 in the HMD 100 is determined depending on the result of the comparison between the maximum luminance value in the capture angle-of-view region 401 and the maximum luminance value in the display angle-of-view region 402 of the corresponding one of the background cameras 102 and 103. Alternatively, the angle-of-view region to be used for the adjustment of the brightness of the displayed image is determined. Specifically, in the case where the presence or absence of the light source varies between the capture angle of view and the display angle of view, the brightness of at least part of the image region corresponding to the display angle of view is adjusted depending on the presence or absence of the light source. For example, in the case where the light source is present in the capture angle of view but is absent in the display angle of view, correction is performed such that the brightness of an object in at least part of the image region corresponding to the display angle of view is increased. This can suppress the decrease in visibility while inhibiting the visually induced motion sickness and the decrease in realistic sensation that occur due to frequent changes in the brightness of the displayed image.

### Embodiment 2

In Embodiment 1, description is given of the method in which the angle-of-view region to be used for the calculation of the exposure of the background camera is determined based on the absolute difference between the maximum luminance values of the capture angle-of-view region and the display angle-of-view region. In Embodiment 2, the position of the light source in the captured image is further calculated, and the exposure is calculated with the position of the light source taken into consideration. In Embodiment 2, this can reduce an amount of change in the exposure in the case where the position of the light source in the captured image moves beyond a boundary of the display region and the angle-of-view region to be used for the calculation of the exposure is switched.

Since the configurations of the HMD 100 and the information processing apparatus 101 in Embodiment 2 are the same as those in Embodiment 1, description thereof is omitted.

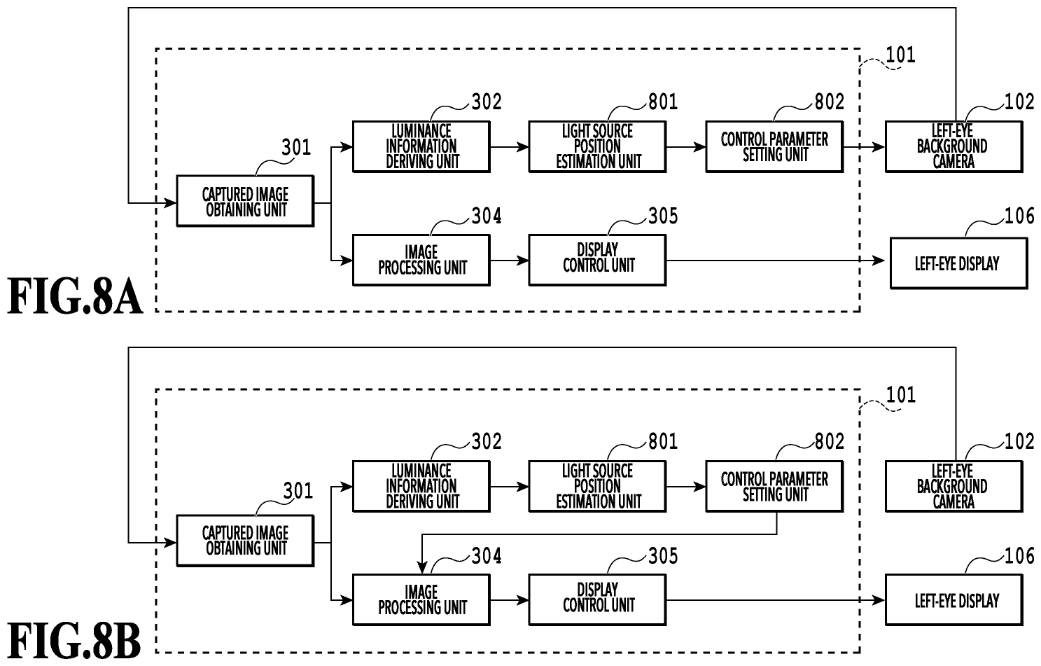

FIGS. 8A and 8B are block diagrams illustrating a functional configuration of the information processing apparatus 101 in Embodiment 2. Since the captured image obtaining unit 301, the luminance information deriving unit 302, and the display control unit 305 perform the same processes as those in Embodiment 1, description thereof is omitted. Moreover, as illustrated in FIGS. 8A and 8B, although two configurations varying in the feedback control method can be adopted as in Embodiment 1, since differences in processes due to differences in these configurations are the same as those in Embodiment 1, description thereof is omitted. Meanwhile, description is given below of a light source position estimation unit 801 that is added to Embodiment 1 and a control parameter setting unit 802 that partially varies in the processing method from that in Embodiment 1.

The light source position estimation unit 801 estimates the position of the light source 501 from the luminance image calculated in the luminance information deriving unit 302, in response to an instruction from the CPU 201. Since the light source 501 has higher luminance than other subjects, for example, the light source position estimation unit 801 can extract a pixel group with pixels values equal to or larger than a predetermined luminance value by threshold processing as a pixel group corresponding to the light source 501, and estimate the position of the light source 501 based on the position of the extracted pixel group. Alternatively, the light source position estimation unit 801 may estimate, among pixel groups with pixel values equal to or larger than the predetermined luminance value, a pixel group in which a predetermined number or more of pixels are consecutively arranged as the light source.

The control parameter setting unit 802 determines the exposure of the left-eye background camera 102 based on the position of the light source 501 calculated in the light source position estimation unit 801 and the luminance information of the capture angle-of-view region and the display angle-of-view region, in response to an instruction from the CPU 201. For example, the exposure set based on the luminance information of the capture angle-of-view region 401 and the exposure set based on the luminance information of the display angle-of-view region 402 are calculated in advance, and are weighted-averaged by using the light source position to calculate the exposure. For example, weights in this case can be determined depending on a ratio between a distance from the light source to a boundary of the display angle-of-view region and a distance from the light source to a boundary of the capture angle-of-view region. Note that the exposure set in this case refers to the imaging parameter (ISO sensitivity, shutter speed, aperture value, and the like) of the left-eye background camera 102 described in Embodiment 1, and the exposure is assumed to be controllable stepwise. Moreover, in the case where the light source is absent in the captured image and the light source position estimation unit 801 thus cannot calculate the light source position or the case where the light source position is in the display angle-of-view region 402, a contribution ratio to the exposure based on the display angle-of-view region 402 is set to 0, and a contribution ratio to the exposure based on the capture angle-of-view region 401 is set to 1. This allows the exposure to be determined based on the luminance information of the capture angle-of-view region 401 in a scene in which no decrease in visibility occurs as in Embodiment 1.

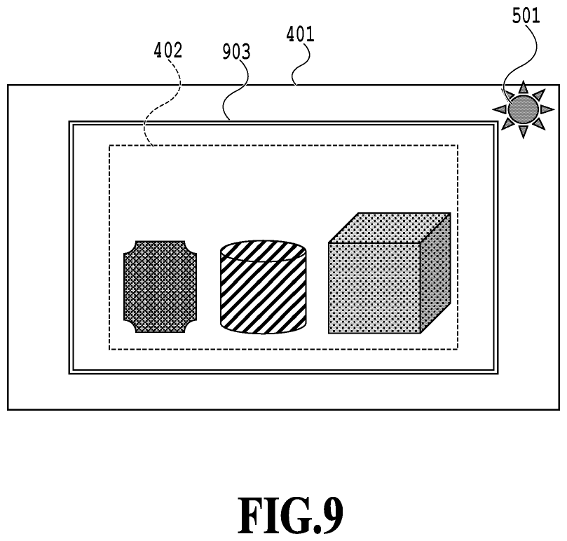

Moreover, the control parameter setting unit 802 may dynamically change a range used to set the exposure depending on the light source position. In FIG. 9, an exposure determination region 903 (double line region in FIG. 9) is a region smaller than the capture angle-of-view region 401 and larger than the display angle-of-view region 402. The control parameter setting unit 802 sets the range such that the light source is not included in the exposure determination region 903, based on the light source position obtained by the light source position estimation unit 801. Reflection of this setting to the setting of the background camera may be achieved by setting the photometric range of the not-illustrated photometric sensor attached to the left-eye background camera 102 to correspond to the exposure determination region 903, or by changing the imaging parameter based on luminance information of the exposure determination region 903.

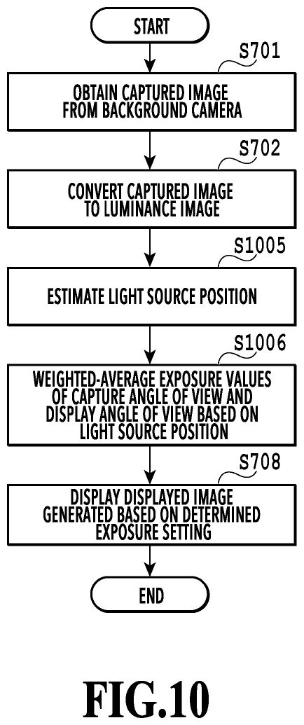

FIG. 10 illustrates a flowchart illustrating a flow of processing in Embodiment 2.

Since the processes of S701 and S702 are the same as those in Embodiment 1, description thereof is omitted. In the case where the process of S702 is completed, the processing proceeds to S1005.

In S1005, the light source position estimation unit 801 extracts the pixel group with luminance values equal to or larger than the predetermined luminance value in the luminance image obtained in S702, and estimates the light source position from the position of the extracted pixel group, and the processing proceeds to S1006.

In S1006, the control parameter setting unit 802 calculates the exposure in the capture angle of view and the exposure in the display angle of view, and calculates the exposure obtained by weighted-averaging the two exposures while weighting the exposures based on the light source position calculated in S1005, and the processing proceeds to S708. Note that the exposure in the capture angle of view is calculated from the luminance information in the capture angle-of-view region 401, and the exposure in the display angle of view is calculated from the luminance information in the display angle-of-view region 402.

S708 is the same as that in Embodiment 1, and the display control unit 305 displays the captured image of the left-eye background camera 102 for which the imaging parameter are set based on the exposure determined in S1006, or displays the displayed image obtained by correcting the brightness of the captured image based on the determined exposure, on the left-eye display 106. In the case where the process of S708 is completed, the series of processes in Embodiment 2 is terminated.

Note that the processing in Embodiment 2 may be processing in which S706 in the processing of Embodiment 1 illustrated in FIG. 7 is replaced by S1005 and S1006. In this case, only the region that is inside the capture angle-of-view region and outside the display angle-of-view region needs to be processed for the estimation of the position of the light source by the light source position estimation unit 801.

Moreover, in the case where multiple light sources are detected in the present embodiment, exposures are first determined based on the respective light source positions, and then a weighted average of the multiple exposures determined based on the respective light source positions is obtained. Weights for the respective exposures may be set based on the luminance values of the pixel groups corresponding to the light sources and a ratio of the number of pixels.

As described above, determining the exposure or the brightness by calculating the position of the light source in the captured image and weighted-averaging the exposures of the capture angle-of-view region and the display angle-of-view region weighted based on the position of the light source or the brightness of the displayed image enables a smoother change of the brightness of the displayed image. This can suppress the amount of change in the exposure to a small level in the case where the position of the light source in the captured image moves beyond the boundary of the display region and the angle-of-view region to be used for the calculation of the exposure or the brightness is switched.

### Embodiment 3

In Embodiment 2, description is given of the method of determining the exposure by calculating the light source position in the captured image and weighted-averaging the exposure in the capture angle of view and the exposure in the display angle of view based on the light source position. Since the exposure of the background camera needs to be determined in real time in an actual usage environment of the HMD, it is desirable to reduce a calculation amount in this case. Accordingly, in Embodiment 3, description is given of a method in which, instead of calculating the luminance each of the capture angle-of-view region and the display angle-of-view region in the captured image every time, the luminance information of the capture angle-of-view region and the display angle-of-view region is derived from the existing luminance information and a movement amount of the head of the user.

Since the configurations of the HMD 100 and the information processing apparatus 101 in Embodiment 3 are the same as those in Embodiment 1, description thereof is omitted.

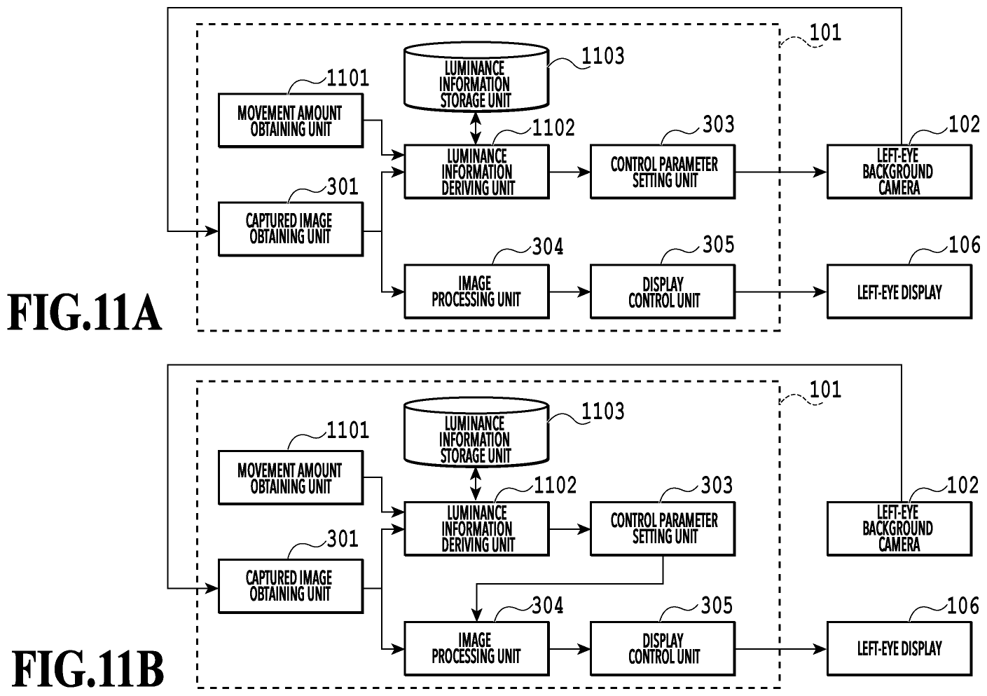

FIGS. 11A and 11B are block diagrams illustrating functional configurations of the information processing apparatus 101 in Embodiment 3. In FIGS. 11A and 11B, since the captured image obtaining unit 301, the control parameter setting unit 303, and the display control unit 305 perform the same processes as those in Embodiment 1, description thereof is omitted. Moreover, as illustrated in FIGS. 11A and 11B, although two configurations varying in the feedback control method can be adopted as in Embodiment 1, since differences in processes due to differences in these configurations are the same as those in Embodiment 1, description thereof is omitted. Meanwhile, description is given below of a movement amount obtaining unit 1101 and a luminance information storage unit 1103 that are added to Embodiment 1 and a luminance information deriving unit 1102 that partially varies in the processing method from that in Embodiment 1.

The movement amount obtaining unit 1101 obtains the head movement amount of the user from a reference position by using a not-illustrated gyroscope sensor attached to the HMD 100, in response to an instruction from the CPU 201. The head movement amount refers to a movement direction and a movement amount from the reference position with a head position of the user at an arbitrary timing set as the reference position. Note that the method of obtaining the head movement amount is not limited to the gyroscope sensor, and it is possible to use other sensors such as an ultrasonic sensor and a LiDAR or to calculate the movement amount by comparing different frames of the captured image.

In the case where the luminance information deriving unit 1102 obtains the captured image from the captured image obtaining unit 301 in response to an instruction from the CPU 201, the luminance information deriving unit 1102 transforms the obtained captured image to the luminance image. The luminance information deriving unit 1102 stores the luminance image in the luminance information storage unit 1103 while associating the luminance image with the head movement amount obtained from the movement amount obtaining unit 1101 at the time of obtaining the captured image. Thereafter, in the case where the luminance information deriving unit 1102 obtains a head movement amount corresponding to a captured image of a current frame from the movement amount obtaining unit 1101, the luminance information deriving unit 1102 determines whether a luminance image associated with a head movement amount matching the head movement amount of the current frame is stored. In the case where the luminance image corresponding to the current frame is stored, the luminance information deriving unit 1102 obtains the corresponding luminance image from the luminance information storage unit 1103 without transforming the captured image of the current frame to the luminance image.

Note that, in the case where the luminance information deriving unit 1102 obtains the luminance image corresponding to the captured image (current frame) obtained in the captured image obtaining unit 301, the luminance information deriving unit 1102 estimates whether each of the capture angle-of-view region 401 and the display angle-of-view region 402 of the current frame includes a high luminance pixel group indicating the light source. This estimation can be performed based on the maximum luminance difference between the angle-of-view regions as in Embodiment 1. Alternatively, the configuration may be such that light source information in which the angle-of-view region including the high luminance pixel group and the head movement amount are associated with each other is held, and the inference is performed based on the light source information and the head movement amount. Note that, in the obtaining of the maximum luminance difference between the angle-of-view regions, it is only necessary to set the maximum luminance value in each of the capture angle-of-view region 401 and the display angle-of-view region 402 to 1 in the case where the region includes the high luminance region and to set the maximum luminance value to 0 in the case where the region does not include the high luminance region. Setting the threshold setting to 1 in the control parameter setting unit 303 enables easy determination of a scene in which the difference between the luminance of the capture angle-of-view region 401 and the luminance of the display angle-of-view region 402 is large.

The luminance information storage unit 1103 obtains the luminance image associated with the head movement amount from the luminance information deriving unit 1102, and stores the luminance image such that the corresponding luminance image and the angle-of-view information to be used for the calculation of the exposure can be extracted based on the head movement amount.

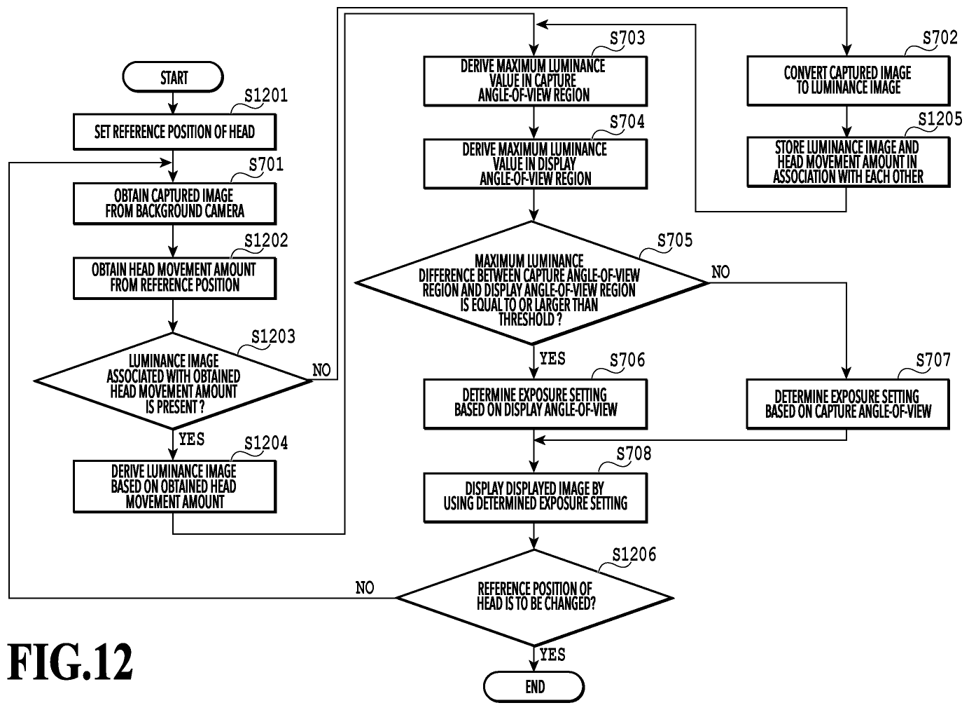

FIG. 12 illustrates a flowchart illustrating a flow of processing in Embodiment 3. Note that, in the processing illustrated in FIG. 12, the luminance information deriving unit 1102 is configured to set the exposure based on the angle of view determined based on the maximum luminance difference between the angle-of-view regions as in Embodiment 1.

In S1201, the movement amount obtaining unit 1101 sets the reference position of the head of the user at the arbitrary timing, and the processing proceeds to S701.

In S701, the captured image obtaining unit 301 obtains the captured image obtained by being captured by the left-eye background camera 102, and the processing proceeds to S1202.

In S1202, the movement amount obtaining unit 1101 obtains the movement amount of the head from the reference position set in S1201, and the processing proceeds to S1203.

In S1203, the luminance information deriving unit 1102 obtains the head movement amount from the movement amount obtaining unit 1101, and determines whether a luminance image associated with the obtained head movement amount is present in the luminance information storage unit 1103. The processing proceeds to S1204 in the case where the corresponding luminance image is present, and proceeds to S702 in the case where the corresponding luminance image is absent.

In S1204, the luminance information deriving unit 1102 derives the luminance image associated with the head movement amount obtained from the movement amount obtaining unit 1101, and the processing proceeds to S703.

In S702, the luminance information deriving unit 1102 transforms the captured image to the luminance image, and the processing proceeds to S1205.

In S1205, the luminance information deriving unit 1102 stores the luminance image transformed from the captured image in the luminance information storage unit 1103 while associating the luminance image with the corresponding head movement amount.

Since the processes from S703 to S708 are the same as those in Embodiment 1, description thereof is omitted.

In S1206, the movement amount obtaining unit 1101 determines whether a change of the reference position is necessary and whether regeneration of the luminance image is necessary due to a change in the arrangement of the light source. In the case where the change of the reference position and the regeneration of the luminance image are unnecessary, the processing returns to S701. In the case where the change of the reference position or the regeneration of the luminance image is necessary, the series of processes in Embodiment 3 is terminated.

Note that, in the case where the comparison of the maximum luminance values is performed as in Embodiment 1, the comparison result of the maximum luminance values in the control parameter setting unit 303 may be associated with the head movement amount, and stored in the luminance information storage unit 1103 together with the luminance image. The angle-of-view region to be used for the exposure setting can be thereby derived from the head movement amount without comparison of the maximum luminance values. Moreover, in the case where the weighting depending on the light source position is performed, the weights for the capture angle of view and the display angle of view or the contribution ratios of these angles of views to the exposure determined in the control parameter setting unit 303 depending on the light source position may be associated with the head movement amount, and stored in the luminance information storage unit 1103 together with the luminance image. The contribution ratio of each angle of view to the exposure or the weight for each angle of view based on the light source position can be thereby derived from the head movement amount. In the case where the angle-of-view region to be used for the exposure setting or the contribution ratio of each angle of view to the exposure or the weight for each angle of view based on the light source position can be derived from the head movement amount as described above, the processes of S703 to S705 can be omitted in addition to S702 and S1205.

Moreover, the imaging parameter or the image processing parameter based on the exposure determined in the control parameter setting unit 303 may be associated with the head movement amount, and stored in the luminance information storage unit 1103. Since the luminance image is unnecessary in this case, the control parameter setting unit 303 stores only the imaging parameter or the image processing parameter in the luminance information storage unit 1103 while associating the imaging parameter or the image processing parameter with the head movement amount. Thereafter, the control parameter setting unit 303 derives the imaging parameter or the image processing parameter based on the head movement amount obtained from the movement amount obtaining unit 1101. The imaging parameter or the image processing parameter based on the exposure determined in the control parameter setting unit 303 can be thereby directly derived from the head movement amount. In the case where the imaging parameter or the image processing parameter can be derived from the head movement amount as described above, the processes of S703 to S707 can be omitted in addition to S702 and S1205.

As described above, in Embodiment 3, the luminance image is stored while being associated with the head movement amount of the user, and the exposure of each of the background cameras 102 and 103 or the brightness of each of the displayed images is determined by using the luminance image derived from among the stored luminance images based on the head movement amount. In Embodiment 3, storing the luminance images in association with the head movement amounts and taking out the luminance image with the matching head movement amount from among the stored luminance images to use the luminance image can reduce the calculation amount while achieving the same effects as those in Embodiment 1.

### Other Embodiments

In Embodiment 1, description is given by using the RGB image as an example of the captured image. However, the captured image is not limited to a RGB format. For example, the captured image may be an image of a format represented by YUV or a monochrome image, and may be any image as long as the image can be transformed to an image representing luminance in each image format. Furthermore, although the maximum luminance value in each of the capture angle-of-view region and the display angle-of-view region is calculated in the luminance information deriving unit 302, the calculated value is not limited to the maximum value of the luminance value in each angle-of-view region, and may be other representative values such as an average value or a median value of the luminance value in each angle-of-view region.

Although the exposure is determined by calculating the position of the light source and weighted-averaging the exposure in the capture angle of view and the exposure in the display angle of view based on the position of the light source in Embodiment 2, the weighted-averaging may be performed depending on a ratio between the luminance of the capture angle-of-view region and the luminance of the display angle-of-view region.

Moreover, the present embodiment can be applied not only to the HMD 100 but also to a system that displays part of the capture angle-of-view region on a display. For example, the configuration of present embodiment can be applied also to a system that displays a portion of the captured image on a back-side monitor as a live-view function of a camera.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In the present disclosure, in the case where the displayed image with a smaller angle of view than the captured image is displayed, the brightness of the displayed image can be appropriately set depending on the position of the light source.

What is claimed is:

1. An information processing apparatus comprising:
an image obtaining unit that obtains a captured image;
an image processing unit that generates a displayed image with a smaller angle of view than the captured image by cutting out part of the captured image; and
a setting unit that sets a control parameter for adjusting brightness of the displayed image based on a region corresponding to the displayed image and a high luminance region having a higher luminance than other regions in the captured image.

2. The information processing apparatus according to claim 1, wherein the setting unit determines contribution ratios of luminance of the captured image and luminance of the displayed image to the brightness of the displayed image, depending on a position of the high luminance region with respect to the region corresponding to the displayed image.

3. The information processing apparatus according to claim 2, wherein the setting unit determines the contribution ratios of the luminance of the captured image and the luminance of the displayed image based on a distance from the high luminance region to a boundary of the captured image and a distance from the high luminance region to a boundary of the displayed image.

4. The information processing apparatus according to claim 2, wherein the setting unit sets the contribution ratio of the luminance of the displayed image such that the closer the position of the high luminance region to the region corresponding to the displayed image is, the higher the contribution ratio is.

5. The information processing apparatus according to claim 1, wherein the high luminance region is a region formed of a pixel group with pixels values equal to or larger than a predetermined luminance value.

6. The information processing apparatus according to claim 1, wherein the setting unit includes a calculation unit that calculates an absolute difference between a representative value of luminance of the captured image and a representative value of luminance of the displayed image, and
in the case when the absolute difference is equal to or larger than a predetermined threshold, the setting unit maximizes a contribution ratio of the luminance of the displayed image.

7. The information processing apparatus according to claim 6, wherein, in the case when the absolute difference is smaller than the predetermined threshold, the setting unit maximizes a contribution ratio of the luminance of the captured image.

8. The information processing apparatus according to claim 6, wherein each of the representative values is one of a maximum value, an average value, and a median value.

9. The information processing apparatus according to claim 1, wherein the control parameter is an imaging parameter of an imaging apparatus.

10. The information processing apparatus according to claim 9, wherein the imaging parameter is an imaging parameter for adjusting exposure of the imaging apparatus.

11. The information processing apparatus according to claim 9, wherein the imaging parameter is an imaging parameter for adjusting an exposure determination region of the imaging apparatus.

12. The information processing apparatus according to claim 1, wherein the control parameter is an image processing parameter for adjusting the brightness of the displayed image in the image processing unit.

13. The information processing apparatus according to claim 1, further comprising:
a deriving unit that derives a luminance image based on the captured image;
a display control unit that displays the displayed image on a video see-through head mounted display including an imaging apparatus; and
a movement amount obtaining unit that obtains a movement amount of the head mounted display,
wherein the deriving unit stores the luminance image and the movement amount in a storage apparatus in association with each other and, in a case where the luminance image associated with the movement amount obtained from the movement amount obtaining unit is present in the storage apparatus, derives the luminance image from the storage apparatus based on the movement amount.

14. The information processing apparatus according to claim 1, further comprising:
a deriving unit that derives a luminance image based on the captured image;
a display control unit that displays the displayed image on a video see-through head mounted display including an imaging apparatus; and
a movement amount obtaining unit that obtains a movement amount of the head mounted display,
wherein the deriving unit stores the luminance image and the control parameter in a storage apparatus in association with each other and, in a case where the control parameter associated with the movement amount obtained from the movement amount obtaining unit is present in the storage apparatus, derives the control parameter from the storage apparatus based on the movement amount.

15. An information processing method comprising:
obtaining a captured image obtained by being captured with an imaging apparatus;
generating a displayed image with a smaller angle of view than the captured image by cutting out part of the captured image; and
adjusting brightness of the displayed image based on a region corresponding to the displayed image and a high luminance region having a higher luminance than other regions in the captured image.

16. A non-transitory computer readable storage medium storing a program that causes a computer to execute an information processing method comprising:
obtaining a captured image obtained by being captured with an imaging apparatus;
generating a displayed image with a smaller angle of view than the captured image by cutting out part of the captured image; and
adjusting brightness of the displayed image based on a region corresponding to the displayed image and a high luminance region having a higher luminance than other regions in the captured image.
